(19) United States
(12) Patent Application Publication
(10) Pub. No.: US 2022/0413457 A1
(43) Pub. Date: Dec. 29, 2022

(54) DYNAMIC SEATING ARRANGEMENT

(71) Applicant: INTERNATIONAL BUSINESS MACHINES CORPORATION, ARMONK, NY (US)

(72) Inventors: Venkata Vara Prasad Karri, Visakhapatnam (IN); Sarbajit K. Rakshit, Kolkata (IN)

(21) Appl. No.: 17/304,555

(22) Filed: Jun. 23, 2021

(51) Int. Cl. G05B 13/04

(52) U.S. Cl. CPC G05B 13/048; G06Q 10/06315

(57) ABSTRACT

According to one embodiment, a method, computer system, and computer program product for dynamic seating arrangement is provided. The embodiment may include identifying a seating arrangement of a venue. The embodiment may also include identifying an obstruction created by one or more viewers seated in one or more seats within the venue. The embodiment may further include generating a model that minimizes or eliminates the identified obstruction. The embodiment may also include calculating a movement differential for each seat in the identified seating arrangement to replicate the generated model. The embodiment may further include moving each seat according to the calculated movement differential.

### BACKGROUND

The present invention relates generally to the field of computing, and more particularly to seating arrangements.

When viewing a performance or display, a group of viewers is typically oriented toward the area of performance or display screen so as to have a full and complete view. Based on the type of venue, the seating arrangement may take one of several forms, such as auditorium, chevron, classroom, or semi-circular. Depending on the arrangement, some rows may have more seats than others to lessen line-of-sight obstructions a viewer might experience caused by other viewers. In some venues, the floor may be level throughout, such as in a classroom setting. However, other venues have an angled floor with seats further away from the stage or display screen being more elevated than seats closer to the stage or display screen, such as in a movie theater or auditorium.

### SUMMARY

According to one embodiment, a method, computer system, and computer program product for dynamic seating arrangement is provided. The embodiment may include identifying a seating arrangement of a venue. The embodiment may also include identifying an obstruction created by one or more viewers seated in one or more seats within the venue. The embodiment may further include generating a model that minimizes or eliminates the identified obstruction. The embodiment may also include calculating a movement differential for each seat in the identified seating arrangement to replicate the generated model. The embodiment may further include moving each seat according to the calculated movement differential.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for dynamic seating arrangement process according to at least one embodiment.

FIGS. 3A and 3B depict a functional block diagram of dynamic seating arrangement according to at least one embodiment.

FIG. 4 is a block diagram of internal and external components of computers and servers depicted in FIG. 1 according to at least one embodiment.

FIG. 5 depicts a cloud computing environment according to an embodiment of the present invention.

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to seating arrangements. The following described exemplary embodiments provide a system, method, and program product to, among other things, dynamically arrange seating orientation in a viewing area to optimize each individual's view space to be free of, or minimally impacted by, obstacles. Therefore, the present embodiment has the capacity to improve the technical field of seating arrangements by providing a system to orients the seating arrangement to optimize an obstacle free view of a presentation or stage area for each viewer.

As previously described, when viewing a performance or display, a group of viewers is typically oriented toward the area of performance or display screen so as to have a full and complete view. Based on the type of venue, the seating arrangement may take one of several forms, such as auditorium, chevron, classroom, or semi-circular. Depending on the arrangement, some rows may have more seats than others to lessen line-of-sight obstructions a viewer might experience caused by other viewers. In some venues, the floor may be level throughout, such as in a classroom setting. However, other venues have an angled floor with seats further away from the stage or display screen being more elevated than seats closer to the stage or display screen, such as in a movie theater or auditorium.

In many group settings, such as sporting events, play houses, or movie theaters, people sit together in an array. Frequently, people sitting towards the back of the seating area have their view of the stage or screen obstructed, such as by the heads of people sitting closer to the viewing area. Obstructions may be further exacerbated by viewers that stand during a show or presentation, such as to take a photograph. As such, it may be advantageous to, among other things, dynamically adjust a seating arrangement to accommodate each individual's viewing area so that visual obstacles are minimized.

According to at least one embodiment, sensors placed throughout a seating area may be utilized to detect obstacles within an individual's view of a presentation area or display screen. Upon determining each individual that may have an obstacle impacting a view field, a prediction may be calculated as to a distance by which each seat in the original seating arrangement may require adjustment so that each detected obstacle. Once a prediction for each seat position has been calculated, each seat may be adjusted to the calculated position thereby enabling each individual to have an obstacle-free view of the performance area or display screen. In at least one embodiment, each seat within the seating area may be equipped with the ability to adjust a seating position front-to-back, side-to-side, axially, radially, or any combination thereof. Furthermore, a seating height may also be adjusted in at least one embodiment. The mechanisms enabling each seat to adjust are discussed in further detail below.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to dynamically adjust a seating orientation to accommodate each individual in an audience with an optimized viewing area of a presentation space or display screen.

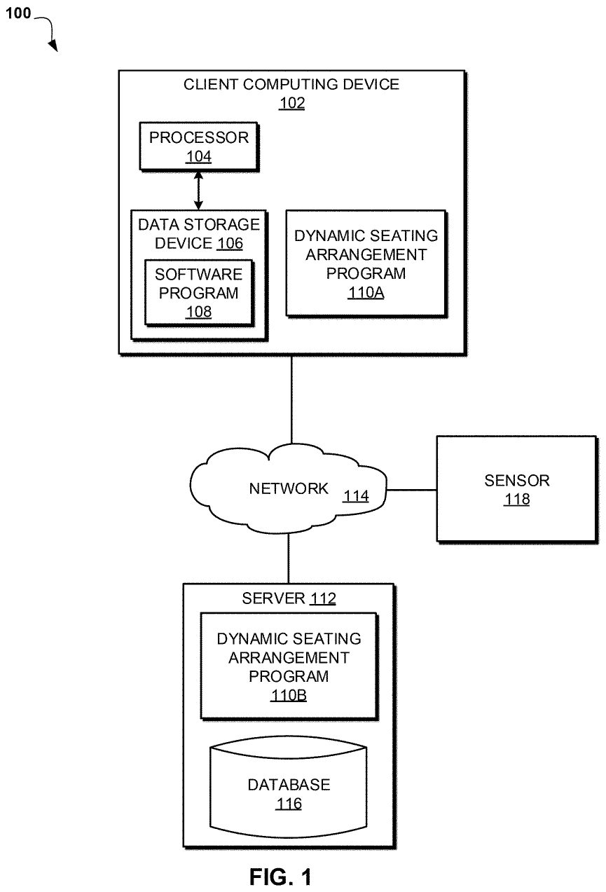

Referring to FIG. 1, an exemplary networked computer environment 100 is depicted, according to at least one embodiment. The networked computer environment 100 may include client computing device 102, a server 112, and one or more sensors 118 interconnected via a communication network 114. According to at least one implementation, the networked computer environment 100 may include a plurality of client computing devices 102, servers 112 and sensors 118, of which only one of each is shown for illustrative brevity. Additionally, in one or more embodiments, the client computing device 102 and server 112 may each individually host a dynamic seating arrangement program 110A, 110B. In one or more other embodiments, the dynamic seating arrangement program 110A, 110B may be partially hosted on both client computing device 102 and server 112 so that functionality may be separated between the devices.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

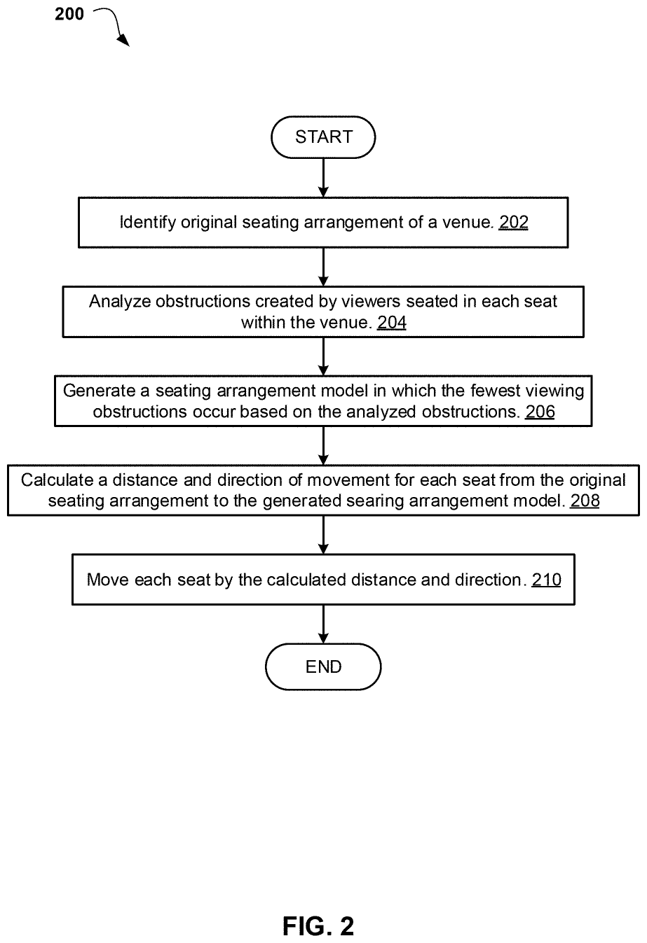

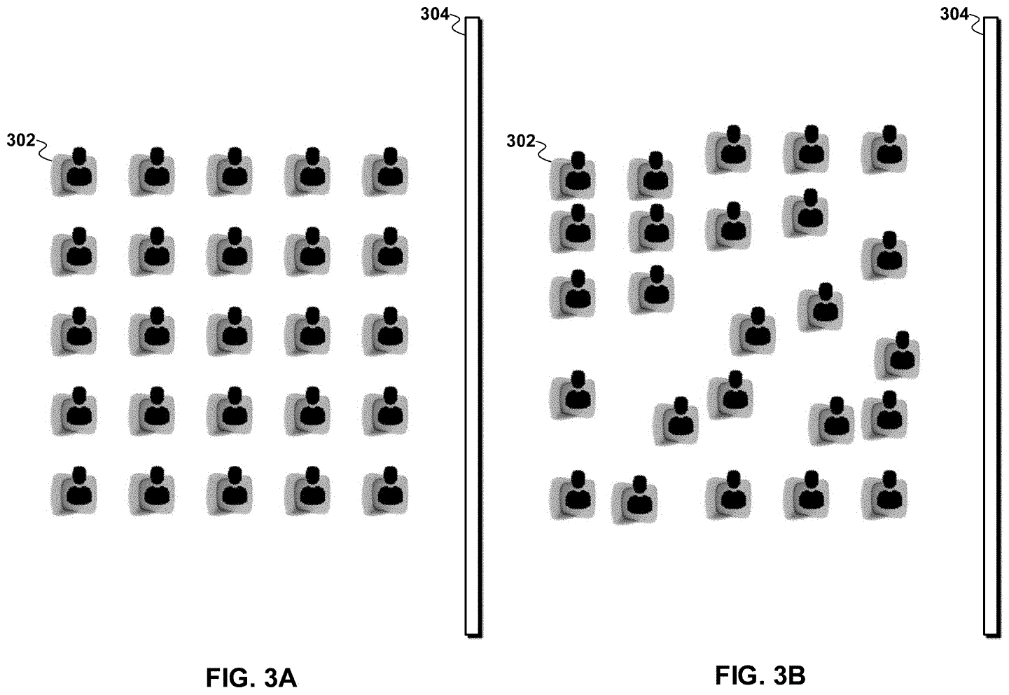

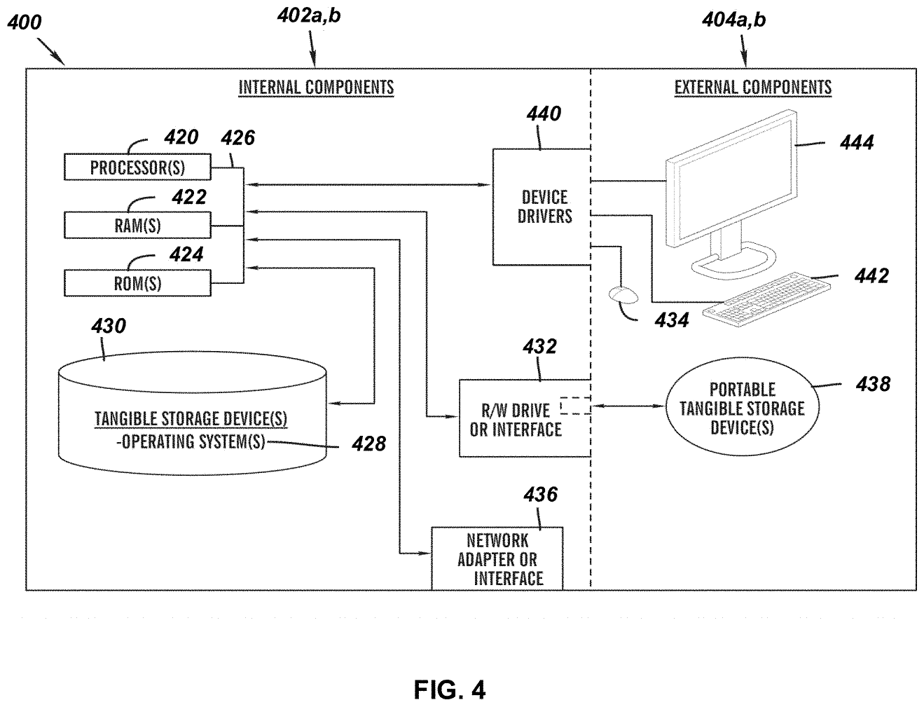

Client computing device 102 may include a processor 104 and a data storage device 106 that is enabled to host and run a software program 108 and a dynamic seating arrangement program 110A, receive data from one or more sensors, such as sensor 118, and communicate with the server 112 via the communication network 114, in accordance with one embodiment of the invention. In at least one embodiment, the client computing device 102 may be an Internet of Things (IoT) seating device capable of being moved, such as through an onboard electric motor, laterally (e.g., side-to-side), longitudinally (i.e., front-to-back), axially, or a combination thereof as well as height adjusted and reclined. In one or more other embodiments, client computing device 102 may be, for example, a mobile device, a telephone, a personal digital assistant, a netbook, a laptop computer, a tablet computer, a desktop computer, or any type of computing device capable of running a program and accessing a network. The client computing device 102 may have one or more sensors, such as sensor 118, internally embedded or externally connected to allow for the capture of individual viewing data and seat positional data. The sensor 118 may include a photographic capture device, a gyroscope, an altimeter, a positioning system, and an ultrasound scanning system. As previously described, one client computing device 102 is depicted in FIG. 1 for illustrative purposes but many client computing devices 102 may be connected via network 114 and moved independently or in conjunction with one another as further described in FIGS. 2, 3A, and 3B. As will be discussed with reference to FIG. 4, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running a dynamic seating arrangement program 110B and a database 116 and communicating with the client computing device 102 via the communication network 114, in accordance with embodiments of the invention. In at least one embodiment, the dynamic seating arrangement program 110B may be a centralized management system for a seating space. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

According to the present embodiment, the dynamic seating arrangement program 110A, 110B may be capable of analyzing the view of each individual in a seating and determining if any one individual has, or may have, an obstruction hindering the individual's view of a presentation or display screen. In response to determining an obstruction is present, the dynamic seating arrangement program 110A, 110B may reorient each seat within the arrangement so that each individual's view of the presentation or display screen is free of obstructions. In at least one embodiment, the dynamic seating arrangement program 110A, 110B may require each user to opt-in to system usage upon a user, or individual, entering a preconfigured threshold distance of a venue seating space or upon the user sitting in a seat in the venue for which the dynamic seating arrangement program 110A, 110B is equipped. The dynamic seating arrangement method is explained in further detail below with respect to FIG. 2.

Referring now to FIG. 2, an operational flowchart illustrating a dynamic seating arrangement process 200 is depicted according to at least one embodiment. At 202, the dynamic seating arrangement program 110A, 110B identifies an original seating arrangement of a venue. As previously described, a seating venue may have seats arrangement in various different formation depending on the venue's design, such as auditorium, chevron, classroom, or semi-circular. The dynamic seating arrangement program 110A, 110B may identify the seating arrangement type as well as the location of each individual seat within the arrangement. In at least one embodiment, the dynamic seating arrangement program 110A, 110B may utilize a coordinate system to calculate the location of each seat within the venue. For example, the dynamic seating arrangement program 110A, 110B may identify an origin point within the venue, such as a point in a lower-left most view of a top down orientation of the venue, and each seat location may be calculated as the distance from the identified origin as an x,y-coordinate or as an angle and distance.

Then, at 204, the dynamic seating arrangement program 110A, 110B analyzes, or identifies, obstacles created by viewers seated in each seat within the venue. The dynamic seating arrangement program 110A, 110B may analyze the venue to identify obstacles, in real time, created by viewers through data capture through the one or more sensors throughout the venue, such as sensor 118. As previously described, the sensor 118 may include a photographic capture device, a gyroscope, an altimeter, a positioning system, and an ultrasound scanning system. The dynamic seating arrangement program 110A, 110B may analyze the venue for obstacles created by viewers seated in each seat in various ways. For example, the dynamic seating arrangement program 110A, 110B may utilize an ultrasound scanning system where each seating unit within the venue has an ultrasound scanning module installed, or individual ultrasound scanning modules are installed elsewhere throughout the venue, to emit ultrasound waves that may be used to identify obstacles within each individual's view of a presentation area or display screen. In at least one embodiment, each module within the ultrasound scanning system that may be installed in each seating unit may be installed in or around a headrest of the seating unit and oriented toward the presentation space or display screen so as to identify any obstacles present in the view space of a seated individual. In another embodiment, the ultrasound scanning system may not initiate individual modules to scan seats or areas where individuals are not seated in order to conserve system resources, such as power consumption and processing power.

In at least one embodiment, the dynamic seating arrangement program 110A, 110B may utilize photographic capture devices, such as cameras, installed within each seating unit or throughout the venue. For example, a photographic capture device installed in each individual seat may be on or near a seat head rest and oriented toward a presentation area or display screen in order to capture a view similar to that of a seated individual. The dynamic seating arrangement program 110A, 110B may then utilize image recognition technology to identify obstacles within each individual's view of the presentation space or display screen.

In yet another embodiment, the dynamic seating arrangement program 110A, 110B may utilize sensors on one or more wearable devices, such as a smart watch or 3D movie glasses, worn my seated individuals in the venue to gather a biometric data feed available from each device. Based on the wearable device feed, the dynamic seating arrangement program 110A, 110B may be capable of predicting or analyzing user behaviors, such as standing up or changing head direction, to determine the type and location of obstacles present within the user's view space of the presentation or display screen. For example, if an associated gyroscope and accelerometer in head-worn wearable determine a user continually moves their head side-to-side, the dynamic seating arrangement program 110A, 110B may determine the user's view is being impeded as well as the estimated location of the impediment based on the distance of the user's side-to-side movements. In yet a further embodiment, the dynamic seating arrangement program 110A, 110B may utilize pressure sensors installed in each seat to capture user movement data useful in understanding user behaviors. For example, if a user's view is impacted by an obstacle, the user may frequently change positions in a seat, which may be captured by installed pressure sensors, such as sensor 118. The dynamic seating arrangement program 110A, 110B may understand the frequent adjustments by the user to identify an obstruction is present.

Next, at 206, the dynamic seating arrangement program 110A, 110B generates a seating arrangement model in which the fewest obstructions occur based on the analyzed obstructions. Using data captured from the one or more sensors within the venue, the dynamic seating arrangement program 110A, 110B may generate a three dimensional model of the original seating arrangement along with the viewers seated within the venue. Based on the model of the original seating arrangement, the dynamic seating arrangement program 110A, 110B may be capable of identifying which viewers have an obstacle impeding a line-of-sight to any portion of a presentation area or display screen. The dynamic seating arrangement program 110A, 110B may modify the seating positions of each seat in the model of the original seating arrangement to optimize each viewer's line-of-sight to the presentation space or display screen so as to reduce or eliminate the presence of any obstacles present in the original model. For example, if an original model of a movie theater seating arrangement identified an obstacle in front of a viewer, the dynamic seating arrangement program 110A, 110B may modify the seat arrangement depicted in the original model by moving each seat in the venue so that the obstacle is removed from the viewer's line-of-sight of the movie screen. The dynamic seating arrangement program 110A, 110B may identify the positions of seats to modify in a selective manner based on the identified obstacles. For example, seats present in areas of the seating arrangement where no obstacles were identified in the original model may remain in their original positions. However, seats in an area of the original model where an obstacle was identified may be moved so as to reduce or eliminate the obstacle in the original model as well as to prevent any obstacles from originating from the seat position modifications. In at least one embodiment, in addition to moving seats two dimensionally (e.g., side-to-side, front-to-back, or a combination thereof), the dynamic seating arrangement program 110A, 110B may also adjust the height (e.g., raising or lowering a seat) of one or more seats in the seating arrangement to optimize a line-of-sight and remove viewing obstacles.

In at least one other embodiment, the dynamic seating arrangement program 110A, 110B may use viewer sitting fatigue and leg room as factors when generating the modified seating arrangement. The dynamic seating arrangement program 110A, 110B may also utilize historical learning from user profiles to determine each viewer's preferred leg room distance and an amount of elapsed time before a user begins to experience fatigue. For example, a user may begin to slump lower in a seat after 30 minutes of being seated, which may require more leg room and a heightening of the user's seat to avoid an obstacle caused by a viewers in more forward seats.

Then, at 208, the dynamic seating arrangement program 110A, 110B calculates a distance and direction of movement for each seat from the original seating arrangement to the generated seating arrangement model. Upon generating the modified seating arrangement model, the dynamic seating arrangement program 110A, 110B may determine a differential between the position of each seat in the original arrangement and the position of each seat in the modified arrangement. The differential may represent the distance and direction by which each seat may be moved in order to achieve an optimal seating arrangement. For example, if an obstacle is blocking an individual's view of a presentation space, the dynamic seating arrangement program 110A, 110B may calculate that the user's seat may need to be moved one foot to the right to remove the obstacle from the individuals view of the presentation space. Accordingly, the dynamic seating arrangement program 110A, 110B may calculate that each seat to the right of the individual's seat may require reorientation accordingly to accommodate movement to the individual's seat as well as maintaining an obstacle free view for any individuals occupying those nearby seats.

Next, at 210, the dynamic seating arrangement program 110A, 110B moves each seat by the calculated distance and direction. As previously described, each seat in the venue seating arrangement may be an IoT device capable of being moved, such as through an onboard electric motor, laterally (e.g., side-to-side), longitudinally (i.e., front-to-back), axially, or a combination thereof as well as height adjusted and/or reclined. In one or more embodiments, each seat may be moved along an electronically-controlled rail system, a system of adjustable hydraulics, mounted and controllable wheel system, or any other system capable of individually moving each seat in the seating arrangement. In at least one other embodiment, each seat may be controlled through a series of Once the differential for each seat has been calculated, the dynamic seating arrangement program 110A, 110B may transmit the calculated differential to each seat to be moved as an instruction thereby causing each seat to reorient the seating arrangement to mirror the modified three dimensional model.

Referring now to FIGS. 3A and 3B, a functional block diagram of dynamic seating arrangement is depicted according to at least one embodiment. In FIG. 3A, a seating arrangement of 25 seats 302 evenly spaced and oriented in a multi-seating surrounding toward a display screen 304 is depicted. Using the equipped sensors, the dynamic seating arrangement program 110A, 110B may determine one or more individuals viewing the display screen 304 has a view of the display screen 304 impacted by an obstacle, such as an appendage of a viewer sitting directly in front of the impacted viewer. In FIG. 3B, a seating arrangement of the same 25 seats 302 is depicted after the dynamic seating arrangement program 110A, 110B has dynamically reoriented each seat 302 so that any individual's view of the display screen 304 previously impacted by an obstacle may not be obstruction free. As is seen in FIG. 3B, the orientation of the seats 302 is no longer evenly spaced but rather spaced to optimally allow the best viewing experience for each user based on the circumstances presented.

It may be appreciated that FIGS. 2, 3A, and 3B provide only an illustration of one implementation and do not imply any limitations with regard to how different embodiments may be implemented. Many modifications to the depicted environments may be made based on design and implementation requirements. In at least one embodiment, if any viewer wants to stand up or otherwise move from the seating space that has been reoriented, the dynamic seating arrangement program 110A, 110B may identify an appropriate path within the modified seating arrangement space. For example, the dynamic seating arrangement program 110A, 110B may incorporate floor lighting to direct a user to a path adjacent to the seating area that may lead the user to a venue exit. Similarly, the dynamic seating arrangement program 110A, 110B may accommodate augmented reality devices, such as AR glasses or smart phones, to visualize a movement path within the modified seating arrangement space. In at least one embodiment, the path a user is directed to traverse by the dynamic seating arrangement program 110A, 110B may be a path calculated by the dynamic seating arrangement program 110A, 110B as one which avoids or creates the fewest disturbances to other individuals in the venue.

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the dynamic seating arrangement program 110A in the client computing device 102 and the dynamic seating arrangement program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the dynamic seating arrangement program 110A, 110B, can be stored on one or more of the respective portable computer-readable tangible storage devices 438, read via the respective R/W drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the dynamic seating arrangement program 110A in the client computing device 102 and the dynamic seating arrangement program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the dynamic seating arrangement program 110A in the client computing device 102 and the dynamic seating arrangement program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

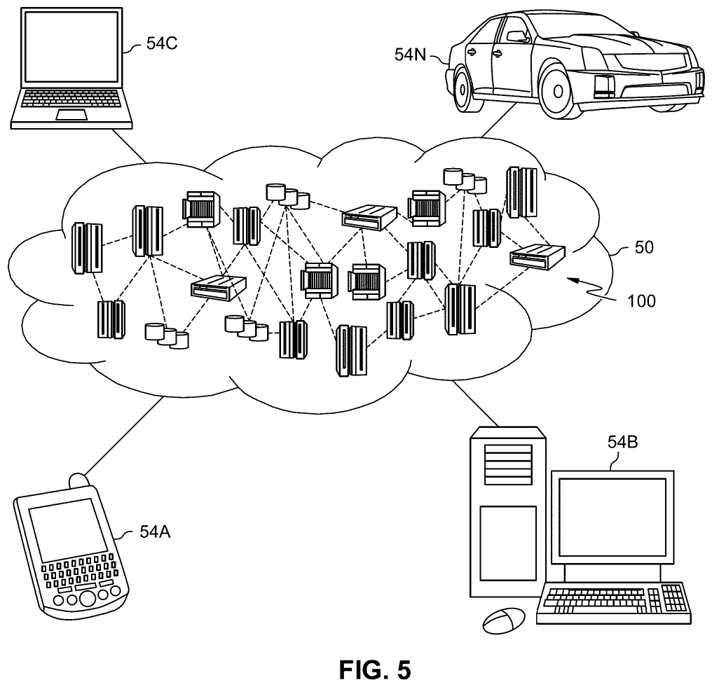

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

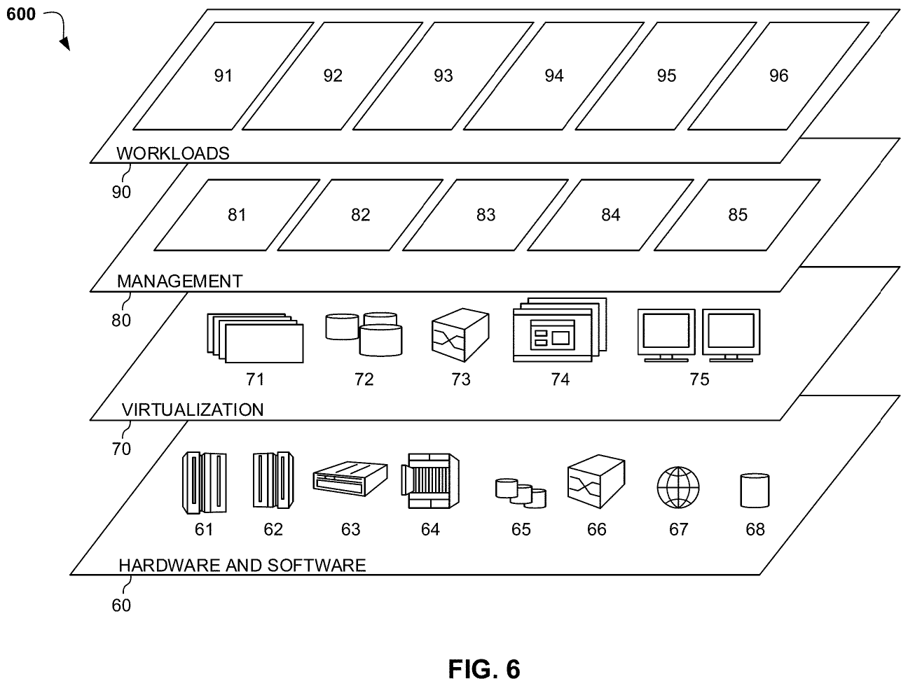

Referring now to FIG. 6, a set of functional abstraction layers 600 provided by cloud computing environment 50 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and dynamic seating arrangement 96. Dynamic seating arrangement 96 may relate identifying obstructions affecting the field of view for individuals in a seating venue and dynamically adjusting the seating arrangement of the venue so as to minimize, or eliminate, the identified obstructions affecting individuals' views of a presentation or display screen.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying a seating arrangement of a venue;
identifying an obstruction created by one or more viewers seated in one or more seats within the venue;
generating a model that minimizes or eliminates the identified obstruction;
calculating a movement differential for each seat in the identified seating arrangement to replicate the generated model; and
moving each seat according to the calculated movement differential.

2. The method of claim 1, wherein the movement differential is a distance and direction by which each seat in the plurality of seats is moved.

3. The method of claim 1, wherein identifying a seating arrangement of the venue further comprises:
identifying an origin point within the venue; and
identifying each seat location in the seating arrangement as a distance and direction from the identified origin point.

4. The method of claim 1, wherein the obstruction is identified by one or more sensors embedded within each seat in the seating arrangement.

5. The method of claim 4, wherein the one or more sensors are selected from a group consisting of a photographic capture device, a gyroscope, an altimeter, a positioning system, and an ultrasound scanning system.

6. The method of claim 1, wherein each seat in the seating arrangement capable of lateral movement, longitudinal movement, axial movement, height adjustment, reclining, or a combination thereof.

7. The method of claim 1, wherein the obstruction is identified by one or more wearable devices worn by a viewer in the venue.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a seating arrangement of a venue;
identifying an obstruction created by one or more viewers seated in one or more seats within the venue;
generating a model that minimizes or eliminates the identified obstruction;
calculating a movement differential for each seat in the identified seating arrangement to replicate the generated model; and
moving each seat according to the calculated movement differential.

9. The computer system of claim 8, wherein the movement differential is a distance and direction by which each seat in the plurality of seats is moved.

10. The computer system of claim 8, wherein identifying a seating arrangement of the venue further comprises:
identifying an origin point within the venue; and
identifying each seat location in the seating arrangement as a distance and direction from the identified origin point.

11. The computer system of claim 8, wherein the obstruction is identified by one or more sensors embedded within each seat in the seating arrangement.

12. The computer system of claim 11, wherein the one or more sensors are selected from a group consisting of a photographic capture device, a gyroscope, an altimeter, a positioning system, and an ultrasound scanning system.

13. The computer system of claim 8, wherein each seat in the seating arrangement capable of lateral movement, longitudinal movement, axial movement, height adjustment, reclining, or a combination thereof.

14. The computer system of claim 8, wherein the obstruction is identified by one or more wearable devices worn by a viewer in the venue.

15. A computer program product, the computer program product comprising:
one or more computer-readable tangible storage medium and program instructions stored on at least one of the one or more tangible storage medium, the program instructions executable by a processor capable of performing a method, the method comprising:
identifying a seating arrangement of a venue;
identifying an obstruction created by one or more viewers seated in one or more seats within the venue;
generating a model that minimizes or eliminates the identified obstruction;
calculating a movement differential for each seat in the identified seating arrangement to replicate the generated model; and
moving each seat according to the calculated movement differential.

16. The method of claim 15, wherein the movement differential is a distance and direction by which each seat in the plurality of seats is moved.

17. The computer program product of claim 15, wherein identifying a seating arrangement of the venue further comprises:
identifying an origin point within the venue; and
identifying each seat location in the seating arrangement as a distance and direction from the identified origin point.

18. The computer program product of claim 15, wherein the obstruction is identified by one or more sensors embedded within each seat in the seating arrangement.

19. The computer program product of claim 18, wherein the one or more sensors are selected from a group consisting of a photographic capture device, a gyroscope, an altimeter, a positioning system, and an ultrasound scanning system.

20. The computer program product of claim 15, wherein each seat in the seating arrangement capable of lateral movement, longitudinal movement, axial movement, height adjustment, reclining, or a combination thereof.
